(19) United States
(12) Patent Application Publication
(10) Pub. No.: US 2025/0349583 A1
(43) Pub. Date: Nov. 13, 2025

(54) SEMICONDUCTOR PROCESSING SYSTEM

(71) Applicant: SAMSUNG ELECTRONICS CO., LTD., Suwon-si (KR)

(72) Inventors: Youngsan PARK, Suwon-si (KR); Chowon Kang, Suwon-si (KR); Euiseok Kum, Suwon-si (KR); Minkyu Sohn, Suwon-si (KR)

(73) Assignee: SAMSUNG ELECTRONICS CO., LTD., Suwon-si (KR)

(21) Appl. No.: 19/025,133

(22) Filed: Jan. 16, 2025

(30) Foreign Application Priority Data
May 8, 2024 (KR) 10-2024-0060461

(51) Int. Cl. H01L 21/67; G06F 30/20; G06F 119/22

(52) U.S. Cl. CPC H01L 21/67276; G06F 30/20; G06F 2119/22

(57) ABSTRACT

A semiconductor processing system includes a plurality of processing modules in which events for a wafer occur and a processor configured to receive system data related to the event and the plurality of processing modules and perform discrete event simulation of an order of occurrence of the events. The processor is configured to select at least one event that may occur after an event on the wafer ends as an event candidate using the system data, determine one of the event candidates as a selected event, store the selected event in an event queue, sequentially proceed with the selected event stored in the event queue, and delete the selected event whose progress has ended from the event queue. When all the selected events stored in the event queue are deleted, the processor is configured to terminate the discrete event simulation and output simulation result data.

### CROSS-REFERENCE TO RELATED APPLICATION(S)

This application claims benefit of priority to Korean Patent Application No. 10-2024-0060461 filed on May 8, 2024 in the Korean Intellectual Property Office, the disclosure of which is incorporated herein by reference in its entirety.

### BACKGROUND

Embodiments are related to a semiconductor processing system.

The productivity of a semiconductor processing system may be determined based on unit per equipment hour (UPEH). The UPEH may indicate the number of wafers that a specific semiconductor processing system produces for one hour, and as the UPEH is higher, the productivity of semiconductor facilities may increase.

By simulating the order of occurrence of events on a wafer, the order of occurrence of events may be analyzed and optimized. In addition, problems that may occur during a semiconductor process may be predicted and prevented in advance. Therefore, productivity may be improved by improving the UPEH of the semiconductor processing system.

### SUMMARY

Embodiments shorten the time required for simulation and improve the consistency of simulation result data by performing discrete event simulation of the order of occurrence of events on a wafer.

Provided herein is a semiconductor processing system including a plurality of processing modules in which a plurality of events for a wafer occur; and a processor configured to receive system data related to: i) a given event of the plurality of events, and ii) the plurality of processing modules, wherein the processor is further configured to perform discrete event simulation of an order of occurrence of each event of the plurality of events, wherein the processor is further configured to: select an end of at least one event that may occur after an earlier-ending event on the wafer as an event candidate of a plurality of event candidates using the system data, determine one of the plurality of event candidates as a selected event, store the selected event in an event queue, sequentially proceed with the selected event stored in the event queue, and delete the selected event whose progress has ended from the event queue, and based on all selected events stored in the event queue being deleted, the processor is configured to terminate the discrete event simulation and output simulation result data.

Also provided herein is a semiconductor processing system including: a plurality of processing modules in which a plurality of events for a wafer occur; and a processor including an engine layer, wherein the engine layer is configured to select event candidates, and an application layer determining one of the event candidates as a selected event, wherein the engine layer is configured to perform discrete event simulation of an order of occurrence of the plurality of events using system data related to the selected event and the plurality of processing modules, wherein the engine layer is further configured to select at least one event that may occur after an end of an earlier-ending event on the wafer as an event candidate using the system data, the application layer is further configured to determine, as the selected event, one event exceeding a restriction condition among the event candidates, and the engine layer is further configured to store the selected event in an event queue in order of high priority, sequentially proceed with the selected event stored in the event queue, and the engine layer is further configured to delete the selected event whose progress has ended from the event queue, and based on all selected events stored in the event queue being deleted, the engine layer is further configured to terminate the discrete event simulation and output simulation result data.

Provided herein is a semiconductor processing system including: a plurality of processing modules in which an event occurs for a lot defined as a group of a plurality of wafers; and a processor configured to receive system data related to the event and the plurality of processing modules and perform discrete event simulation of an order of occurrence of the event, wherein the processor is further configured to select at least one event that may occur after an end of an earlier-ending event performed on one of the plurality of wafers as an event candidate of a plurality of event candidates using the system data and the processor is further configured to determine, as a selected event, one event exceeding a restriction condition among the plurality of event candidates, the processor is further configured to store the selected event in an event queue in order of high priority, sequentially proceed with the selected event stored in the event queue, and delete the selected event whose progress has ended from the event queue, and based on all selected events stored in the event queue being deleted, the processor is further configured to terminate the discrete event simulation and output simulation result data including a start time and an end time of the selected event.

### BRIEF DESCRIPTION OF DRAWINGS

The above and other aspects, features, and advantages will be more clearly understood from the following detailed description, taken in conjunction with the accompanying drawings, in which:

FIG. 1 is a diagram illustrating a system according to an example embodiment;

FIG. 2 is a flowchart illustrating a process of selecting optimal system data for a semiconductor processing system and reflecting the selected optimal system data in the semiconductor processing system according to an example embodiment;

FIG. 3 is a diagram simply illustrating a discrete event simulation system according to an example embodiment;

FIG. 4 is a flowchart illustrating an operation process of a discrete event simulation system according to an example embodiment;

FIG. 5 is a diagram simply illustrating event candidates and a selected event for a single wafer according to an example embodiment;

FIG. 6 is a diagram simply illustrating an event queue for a single wafer according to an example embodiment;

FIG. 7 is a diagram simply illustrating selected events for a plurality of wafers according to an example embodiment; and

FIG. 8 is a diagram illustrating visualization of simulation result data according to an example embodiment.

### DETAILED DESCRIPTION

Hereinafter, example embodiments are described with reference to the accompanying drawings.

Hereinafter, preferred example embodiments will be described with reference to the attached drawings.

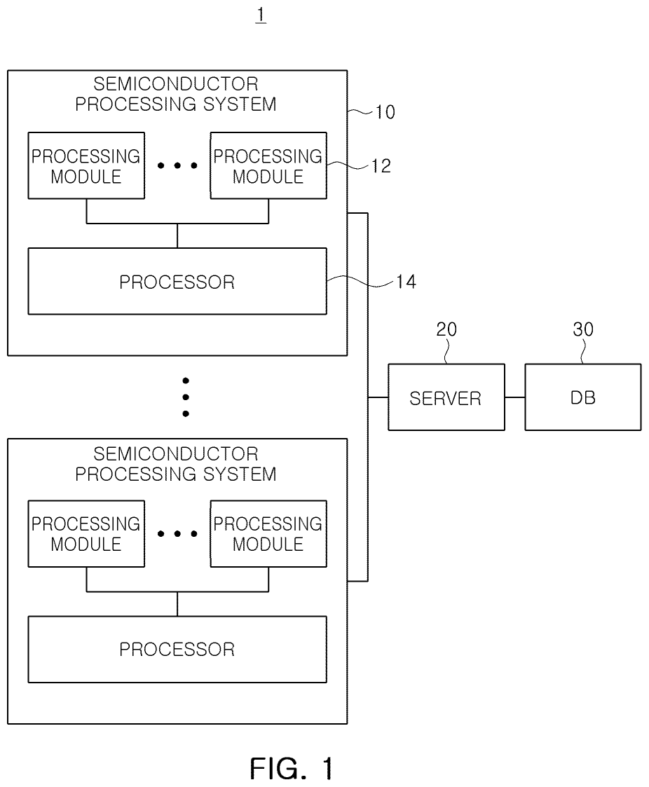

FIG. 1 is a diagram illustrating a system according to an example embodiment.

Referring to FIG. 1, a system 1 may include at least one semiconductor processing system 10, a server 20, and a database (DB) 30. The semiconductor processing system 10 according to an example embodiment may simulate the order of occurrence of events on a wafer before proceeding with a semiconductor process.

The semiconductor processing system 10 may include a plurality of processing modules 12 and a processor 14. An event for a wafer may occur in the plurality of processing modules 12. An event refers to all operations performed on a wafer within a semiconductor processing system, and an event may occur at a specific time.

In an example embodiment, an event of receiving a wafer from outside the semiconductor processing system, an event of aligning the wafer, an event of temporarily maintaining the wafer, an event of moving the wafer to another processing module, and an event of conducting a semiconductor process on a wafer may occur in the plurality of processing modules 12. However, embodiments are not limited thereto.

The processor 14 may perform discrete event simulation of the order of occurrence of the events. Specifically, the processor 14 may perform discrete event simulation on a plurality of wafers included in a lot. The processor 14 may store an event in an event queue using system data, and the system data may be related to an event and a plurality of processing modules. The processor 14 may perform discrete event simulation of the order of occurrence of events by sequentially processing events based on the event queue.

After the discrete event simulation is completed, the semiconductor processing system 10 may produce simulation result data. The simulation result data may include start and end times of each event. From the simulation result data, the time taken for the plurality of wafers included in the lot to be introduced into the semiconductor processing system and discharged may be calculated. Therefore, a unit per equipment hour (UPEH) of the semiconductor processing system 10 may be verified using the simulation result data.

The time taken for a general semiconductor processing system to perform simulation may be similar to the actual operating time of the semiconductor processing system. Accordingly, there may be a limit to the number of times a simulation may be performed.

The semiconductor processing system 10 according to an example embodiment may shorten the time required to perform simulation by performing discrete event simulation of the order of occurrence of events. Accordingly, it is possible to simulate the order of occurrence of events for various system data for a predetermined period of time.

The simulation result data produced by the semiconductor processing system 10 may be transmitted to the server 20. The server 3 may transmit the data received from the semiconductor processing system 10 to the DB 30. The DB 30 may store the data received from the server 20 and may transmit data requested by the server 20 to the server 20.

The system 1 according to an example embodiment may perform discrete event simulation of the order of occurrence of events for each semiconductor processing system 10. By analyzing the simulation result data and optimizing the order of occurrence of events, the process efficiency of the semiconductor processing system 10 may be improved. In addition, the productivity of the semiconductor processing system 10 may be improved by comparing simulation result data for various system data and selecting optimal system data.

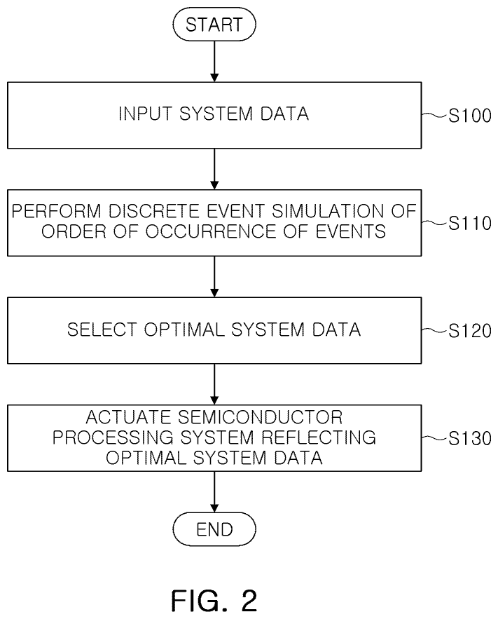

FIG. 2 is a flowchart illustrating a process of selecting optimal system data for a semiconductor processing system and reflecting the selected optimal system data in the semiconductor processing system according to an example embodiment.

A semiconductor processing system according to an example embodiment may include a plurality of processing modules and a processor. An event for a wafer may occur in the plurality of processing modules. The processor may perform discrete event simulation of the order of occurrence of events to produce simulation result data.

Specifically, the processor may perform discrete event simulation of the order of occurrence of events for a plurality of wafers included in a lot. The simulation result data may include start and end times of each event. Specific example embodiments of the semiconductor processing system may be similar to those described above with reference to FIG. 1.

Referring to FIG. 2, system data may be input to the semiconductor processing system (S100). Specifically, system data may be input to the processor, and the system data may be data related to an event and a plurality of processing modules. The system data may include at least one of a configuration of a plurality of processing modules, a relationship between the plurality of processing modules, a layout of the plurality of processing modules, a process recipe, time of a given event, and a process parameter.

At least one of the system data may be randomly input data. Alternatively, at least one of the system data may be data obtained by statistically processing the results of actual operation of the semiconductor processing system. For example, the system data may be an average or median value of the results of the actual operation of the semiconductor processing system. As another example, the system data may be the maximum or minimum value of the results of the actual operation of the semiconductor processing system. However, embodiments are not limited thereto.

The configuration of the plurality of processing modules may include information on an event that may occur in each of the plurality of processing modules. The relationship between the plurality of processing modules may include a precedence relationship regarding the progress of an event that may occur in each of the plurality of processing modules. The layout of the plurality of processing modules may include a physical arrangement of the plurality of processing modules in the semiconductor processing system.

The process recipe may include the order of events (a plurality of events) that the wafer should go through. The time of an event may include operating time of a processing module for a particular event and time of the wafer to move between processing modules (movement time). The process parameter may include, but are not limited to, at least one of RF power, fluid pressure, a fluid flow rate, chamber pressure, and temperature. The process parameter may be changed depending on the process recipe.

The processor may perform discrete event simulation of the order of occurrence of events using the received system data (S110). Here, the processor may perform discrete event simulation of the order of occurrence of events for a plurality of wafers included in the lot. The processor may perform discrete event simulation by changing the system data in various manners, and a plurality of pieces of simulation result data may be produced and output.

The simulation result data may include start and end times of each event. From the simulation result data, the time taken for a plurality of wafers included in the lot to be introduced into the semiconductor processing system and discharged may be calculated. In other words, the UPEH of the semiconductor processing system may be calculated using the simulation result data.

Optimal system data may be selected using the plurality of pieces of simulation result data (S120). For example, the simulation result data in which the highest UPEH is calculated may be determined, and the system data input to the corresponding semiconductor processing system may be selected as the optimal system data. The semiconductor processing system may be operated by reflecting the optimal system data (S130). Accordingly, the yield of the semiconductor processing system may be improved.

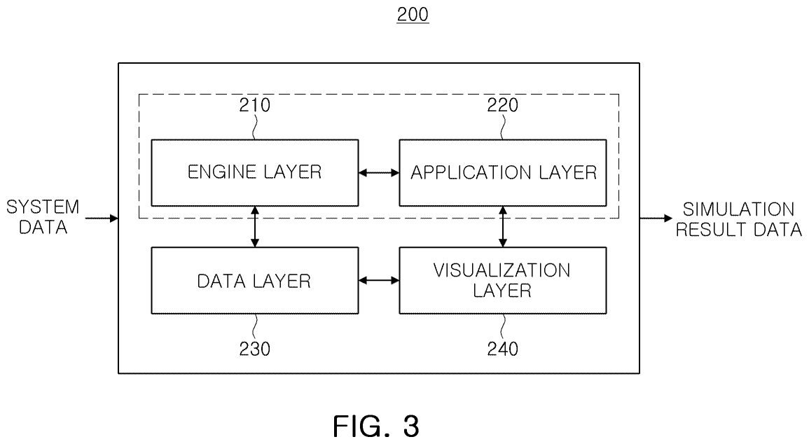

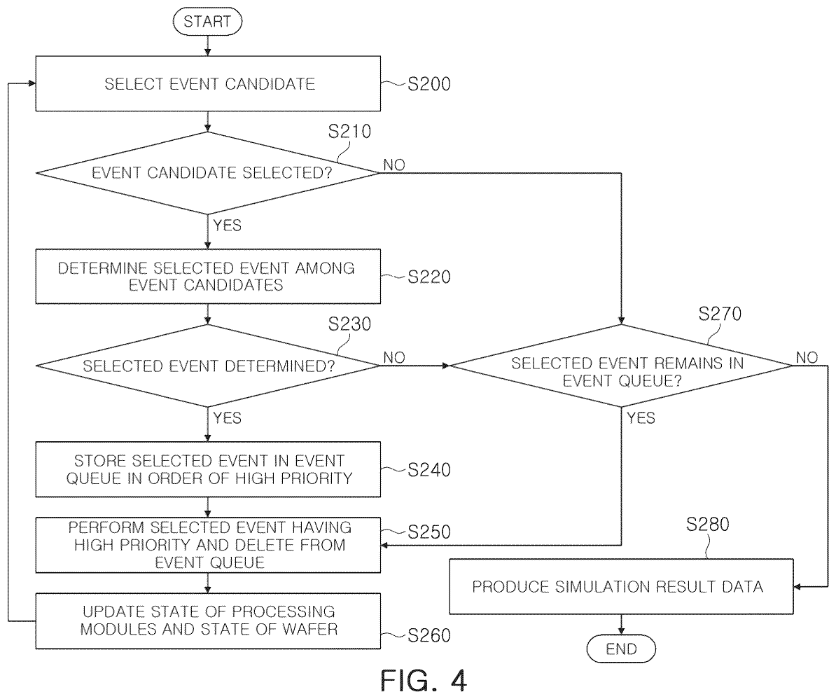

Hereinafter, discrete event simulation of a semiconductor processing system is described in detail with reference to FIGS. 3 and 4.

FIG. 3 is a diagram simply illustrating a discrete event simulation system according to an example embodiment. FIG. 4 is a flowchart illustrating an operation process of the discrete event simulation system according to an example embodiment.

A semiconductor processing system according to an example embodiment may include a plurality of processing modules and a processor. Referring first to FIG. 3, the processor may include a discrete event simulation system 200. The discrete event simulation system 200 may include an engine layer 210, an application layer 220, a data layer 230, and a visualization layer 240. The engine layer 210 and the application layer 220 may configure a simulator.

The discrete event simulation system 200 may receive system data, and the system data may be data related to an event and a plurality of processing modules. The discrete event simulation system 200 may perform discrete event simulation of the order of occurrence of events using the system data and produce and output simulation result data.

Referring to FIGS. 3 and 4, the engine layer 210 may select an event candidate using the system data (S200). The event candidate may be at least one event that may occur after an event (an earlier-ending event) occurring on a wafer ends.

For example, the engine layer 210 may select an event candidate by considering a state of a plurality of processing modules and a state of the wafer. The state of the plurality of processing modules may include whether a wafer is introduced into the processing module, whether the processing module is broken, and whether the processing module may operate normally. The state of the wafer may include the progress of the process recipe, etc. but is not limited thereto.

If an event candidate is selected (YES in S210), the application layer 220 may determine the event selected from the event candidates (S220) (a plurality of event candidates). The application layer 220 may determine one event exceeding restriction conditions among event candidates, as the selected event. The restriction conditions may include at least one of a failure of the processing module in which the event candidate occurs and input of another wafer into the processing module in which the event candidate occurs.

Here, if there are a plurality of events exceeding the restriction conditions among the event candidates, the application layer 220 may determine the selected event using a preset selection logic. For example, the application layer 220 may determine an event candidate for a wafer with a fast number as the selected event. As another example, the application layer 220 may determine an event candidate for a chamber with a fastest number as the selected event. However, embodiments are not limited thereto.

When the selected event is determined (YES in S230), the engine layer 210 may store the selected event in the event queue in order of high priority (S240). In an example embodiment, the engine layer 210 may determine the priority based on the end time of the selected event, and an event having an earlier end time may have higher priority. The engine layer 210 may store the end time of the selected event in the event queue along with the selected event. However, embodiments are not limited thereto.

The engine layer 210 may process the selected event with high priority among the selected events stored in the event queue, and when the process is completed, the engine layer 210 may delete the selected event from the event queue (S250). The engine layer 210 may update the state of the plurality of processing modules and the state of the wafer (S260). Thereafter, the discrete event simulation system 200 may repeat the processes of selecting an event candidate, determining the selected event, and proceeding with the selected event (S200 to S260).

However, if an event candidate has not been selected (NO in S210) or the selected event has not been determined (NO in S230), it may be determined whether the selected event remains in the event queue (S270). If the selected event remains in the event queue (YES in S270), the engine layer 210 may proceed with the selected event with high priority among the selected events remaining in the event queue, and when the process is completed, the engine layer 210 may delete it from the event queue (S250).

If there are no selected events remaining in the event queue (NO in S270), the engine layer 210 may terminate the discrete event simulation and produce the simulation result data (S280). As an example, the simulation result data may include start and end times of the selected event.

The visualization layer 240 may visualize the simulation result data and provide the visualized simulation result data to the user. The visualization layer 240 may visualize the simulation result data in the form of tables, graphs, charts, tree data structures, etc. However, embodiments are not limited thereto.

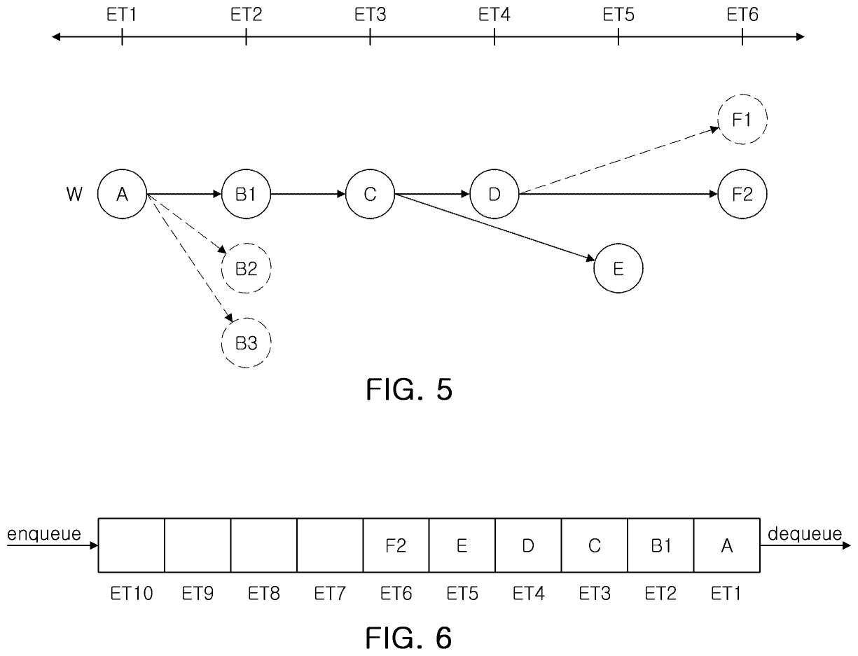

Hereinafter, event candidates and a selected event are described in detail with reference to FIG. 5, and an event queue is described in detail with reference to FIG. 6.

FIG. 5 is a diagram simply illustrating event candidates and a selected event for a single wafer according to an example embodiment. FIG. 6 is a diagram simply illustrating an event queue for a single wafer according to an example embodiment.

A semiconductor processing system according to an example embodiment may include a plurality of processing modules and a processor. The semiconductor processing system may perform discrete event simulation of the order of occurrence of events and produce simulation result data. At this time, the semiconductor processing system may select an event candidate and determine the event selected from the event candidates. Specific example embodiments of the semiconductor processing system may be similar to those described above with reference to FIGS. 1 to 4.

First, referring to FIG. 5, FIG. 5 may illustrate an event candidate for discrete event simulation of the order of occurrence if events for a single wafer in an example embodiment and a selected event. The event candidate and the selected event may each correspond to event times (ET1 to ET6; ET). The event time ET may correspond to an end time of the event. However, embodiments are not limited thereto.

In an example embodiment illustrated in FIG. 5, event candidates for the first event time ET1 to the sixth event time ET6 may be selected as event A to event F2. One selected event may be determined for each event time ET. According to an example embodiment illustrated in FIG. 5, an event determined to be a selected event among event candidates may be illustrated by the solid lines. Among the event candidates, events not determined as selected events may be illustrated by the dotted lines.

Among the event candidates, an event exceeding the restriction conditions may be determined as a selected event. The restriction conditions may include at least one of a failure of the processing module in which the event candidate occurs and introduction of another wafer into the processing module in which the event candidate occurs.

According to an example embodiment illustrated in FIG. 5, event candidates that may occur after event A ends at the first event time ET1 may be event B1 to event B3 at the second event time ET2. At the second event time ET2, event B1 may be determined as the selected event, and event B2 and event B3 may not be determined as the selected event.

An event candidate that may occur after event B1 ends at the second event time ET2 may be event C at the third event time ET3. At the third event time ET3, event C may be determined as the selected event.

Event candidates that may occur after event C ends at the third event time ET3 may be event D at the fourth event time ET4 and event E at the fifth event time ET5. At the fourth event time ET4, event D may be determined as the selected event, and at the fifth event time ET5, event E may be determined as the selected event.

Event candidates that may occur after event D ends at the fourth event time ET4 may be event F1 and event F2 at the sixth event time ET6. At the sixth event time ET6, event F2 may be determined as the selected event, and event F1 may not be determined as the selected event.

Referring to FIG. 6, FIG. 6 may illustrate an event queue in which the selected event of the example embodiment illustrated in FIG. 5 is stored. The event queue of the example embodiment illustrated in FIG. 6 may have ten event times (ET1 to ET10; ET) but is not limited thereto. The event queue may have a first-in first-out (FIFO) structure that sequentially processes events occurring in the simulation. An event first stored in the event queue may proceed first. In other words, as the event time ET corresponding to an event is earlier, the event may proceed first. An end time of the previous event may be the same as a start time of the next event.

Event enqueuing may be performed at the back of the event queue, and event dequeuing may be performed at the front of the event queue. Each selected event may be stored in the event queue to correspond to different event times ET. At this time, the selected events may be sequentially stored one by one in the event queue, or a plurality of events may be stored in the event queue simultaneously. However, embodiments are not limited thereto.

Referring to FIGS. 5 and 6, before the first event time ET1, event A may be selected as an event candidate and may be determined as the selected event. Event A may be stored in the event queue, and event A may correspond to the first event time ET1.

The progress of event A may end at the first event time ET1. Event A may be deleted from the event queue at the first event time ET1. Events B1 to B3 may be selected as event candidates, and event B1 may be determined as a selected event. Event B1 may be stored in the event queue, and event B1 may correspond to the second event time ET2.

The progress of event B1 may start at the first event time ET1 and end at the second event time ET2. Event B1 may be deleted from the event queue at the second event time ET2. Event C is selected as an event candidate and may be determined as the selected event. Event C may be stored in the event queue, and event C may correspond to the third event time ET3.

The progress of event C may start at the second event time ET2 and end at the third event time ET3. Event C may be deleted from the event queue at the third event time ET3. Event D and Event E may be selected as event candidates and may be determined as selected events. In other words, termination of progress of event C may cause event D and event E.

Event D and Event E may be stored in the event queue. Since the end time of event D is earlier than that of event E, the priority of event D may be higher than that of event E. Accordingly, event D may correspond to the fourth event time ET4, and event E may correspond to the fifth event time ET5.

The progress of event D may start at the third event time ET3 and end at the fourth event time ET4. Event D may be deleted from the event queue at the fourth event time ET4. Event F1 and event F2 may be selected as event candidates, and event F2 may be determined as the selected event. Event F2 may be stored in the event queue, and event F2 may correspond to the sixth event time ET6.

The progress of event E may start at the third event time ET3 and end at the fifth event time ET5. Event E may be deleted from the event queue at the fifth event time ET5.

The progress of event F2 may start at the fourth event time ET4 and end at the sixth event time ET6. Event F2 may be deleted from the event queue at the sixth event time ET6.

Referring to FIG. 6, the selected events A to F2 may respectively correspond to the first to sixth consecutive event times ET1 to ET6. Unlike illustrated, the selected events A to F2 may correspond to non-consecutive event times ET. For example, event B1 may correspond to the third event time ET3, and event C may correspond to the sixth event time ET6. However, embodiments are not limited thereto.

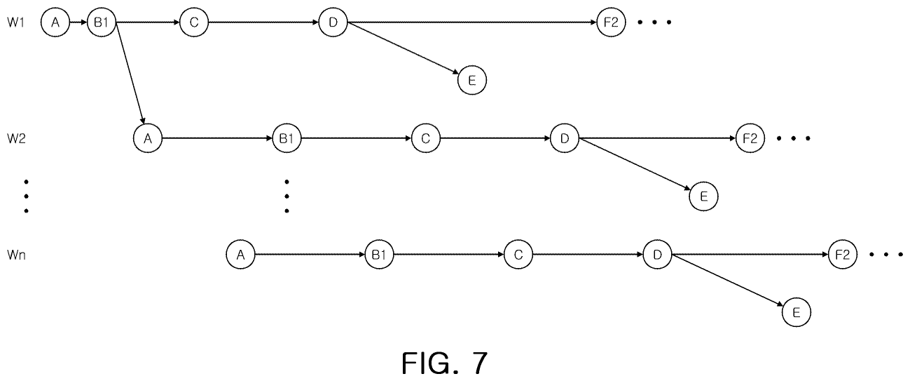

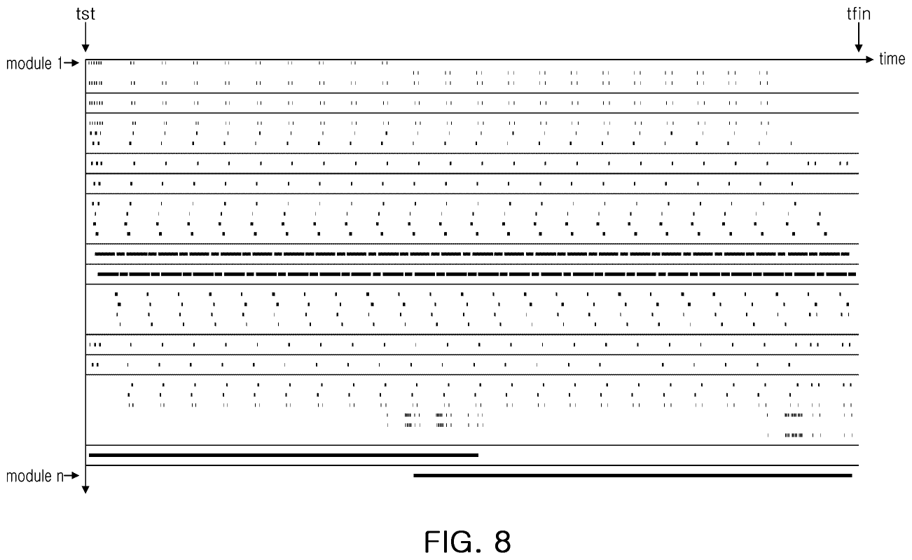

FIG. 7 is a diagram simply illustrating selected events for a plurality of wafers according to an example embodiment. FIG. 8 is a diagram illustrating visualization of simulation result data according to an example embodiment.

The semiconductor processing system of an example embodiment may simulate the order of occurrence of events for a plurality of wafers W1 to Wn. Specific example embodiments of the semiconductor processing system may be similar to those described above with reference to FIGS. 1 to 6. A group of the plurality of wafers W1 to Wn may be defined as a lot. The plurality of wafers W1 to Wn may be provided to the semiconductor processing system on a lot basis. In an example, the lot may include, but is not limited to, 24 wafers.

First, referring to FIG. 7, FIG. 7 may illustrate selected events for performing discrete event simulation of the order of occurrence of events for the plurality of wafers W1 to Wn in an example embodiment. Event candidates and selected events for each of the plurality of wafers W1 to Wn may include an example embodiment illustrated in FIG. 5.

The selected events illustrated in FIG. 7 may correspond to different event times ET, respectively. The selected events may be stored in the event queue and proceed sequentially. The event time ET may correspond to the time when the progress of the event ends but is not limited thereto.

At the first event time ET1, the progress of event A for the first wafer W1 may end. At the second event time ET2, the progress of event B1 for the first wafer W1 may end. Termination of the progress of event B1 for the first wafer W1 may cause event C for the first wafer W1 and event A for the second wafer W2.

The end time of event A for the second wafer W2 may be different from the end time of event C for the first wafer W1. For example, the third event time ET3, which is the end time of event A for the second wafer W2, may be earlier than the fourth event time ET4, which is the end time of event C for the first wafer W1. However, embodiments are not limited thereto.

Thereafter, selected events for the first wafer W1 to the n-th wafer Wn may occur sequentially. When the progress of all the selected events terminates, the discrete event simulation may terminate. In other words, if there are no selected events remaining in the event queue, the discrete event simulation may terminate and simulation result data may be produced.

The simulation result data may include the start time and end time of each selected event. The semiconductor processing system may visualize the simulation result data and provide the same to the user. The simulation result data may be visualized in the form of diagrams, graphs, charts, tree data structures, etc., but is not limited thereto.

Referring to FIG. 8, FIG. 8 may visualize simulation result data produced by proceeding with a selected event of an example embodiment illustrated in FIG. 7.

The horizontal axis of FIG. 8 may correspond to time, and the vertical axis may correspond to a plurality of processing modules included in the semiconductor processing system. FIG. 8 may illustrate the time at which a selected event progressed in each of a plurality of processing modules. The time for which the selected event has been performed may correspond to duration from the start time to end time of the event. FIG. 8 represents the fabrication of wafers w1 through wn of FIG. 7. A moment in time when a given module is processing a wafer is marked with a “+”. An efficiency of the event selection of FIG. 7 is indicated by the number of wafers fabricated between the times tst and tfin of FIG. 7.

The discrete event simulation of an example embodiment illustrated in FIG. 8 may start at a simulation start time tst and end at a simulation end time tfin. The simulation end time tfin may coincide with the end time of the last selected event. The time spent in the discrete event simulation may correspond to duration from the simulation start time tst to the simulation end time tfin. In an example, the time spent for discrete event simulation may be less than 1 second, but is not limited thereto.

From the simulation result data, the time taken for a plurality of wafers included in the lot to be introduced into the semiconductor processing system and discharged therefrom may be calculated. Using the simulation result data, the UPEH of the semiconductor processing system may be calculated. Therefore, the productivity of the semiconductor processing system may be verified.

According to an example embodiment, by performing discrete event simulation of the order of occurrence of events using system data related to the event and a plurality of processing modules, the time required for simulation may be shortened and the consistency of the simulation result data may be improved.

While example embodiments have been illustrated and described above, it will be apparent to those skilled in the art that modifications and variations could be made without departing from the scope of the appended claims.

What is claimed is:

1. A semiconductor processing system comprising:
a plurality of processing modules in which a plurality of events for a wafer occur; and
a processor configured to receive system data related to: i) a given event of the plurality of events, and ii) the plurality of processing modules, wherein the processor is further configured to perform discrete event simulation of an order of occurrence of each event of the plurality of events,
wherein the processor is further configured to:
select an end of at least one event that may occur after an earlier-ending event on the wafer as an event candidate of a plurality of event candidates using the system data,
determine one of the plurality of event candidates as a selected event,
store the selected event in an event queue,
sequentially proceed with the selected event stored in the event queue, and
delete the selected event whose progress has ended from the event queue, and
based on all selected events stored in the event queue being deleted, the processor is configured to terminate the discrete event simulation and output simulation result data.

2. The semiconductor processing system of claim 1, wherein the system data comprises at least one of a configuration of the plurality of processing modules, a relationship between the plurality of processing modules, a layout of the plurality of processing modules, a process recipe, time of the event, and a process parameter.

3. The semiconductor processing system of claim 2, wherein the time of the event comprises an operation time of the plurality of processing modules according to the event and a movement time for the wafer to move between the plurality of processing modules.

4. The semiconductor processing system of claim 2, wherein the process parameter comprises at least one of RF power, fluid pressure, a fluid flow rate, chamber pressure, and temperature.

5. The semiconductor processing system of claim 1, wherein the processor is further configured to select, as the event candidate, at least one second event that may occur after a first event in progress on the wafer is completed, in consideration of a first state of the plurality of processing modules and a first state of the wafer.

6. The semiconductor processing system of claim 1, wherein the processor is further configured to determine one event exceeding a restriction condition among the plurality of event candidates as the selected event.

7. The semiconductor processing system of claim 6, wherein the restriction condition comprises at least one of a failure of a processing module in which the event candidate occurs and introduction of another wafer into the processing module in which the event candidate occurs.

8. The semiconductor processing system of claim 6, wherein the processor is further configured to determine priority based on an end time of the selected event and stores the selected event in the event queue in order of high priority.

9. The semiconductor processing system of claim 1, wherein the processor is further configured to store an end time of the selected event in the event queue along with the selected event.

10. The semiconductor processing system of claim 1, wherein the simulation result data comprises a start time and an end time of the selected event.

11. A semiconductor processing system comprising:
a plurality of processing modules in which a plurality of events for a wafer occur; and
a processor including an engine layer, wherein the engine layer is configured to select event candidates, and an application layer determining one of the event candidates as a selected event, wherein the engine layer is configured to perform discrete event simulation of an order of occurrence of the plurality of events using system data related to the selected event and the plurality of processing modules,
wherein the engine layer is further configured to select at least one event that may occur after an end of an earlier-ending event on the wafer as an event candidate using the system data,
the application layer is further configured to determine, as the selected event, one event exceeding a restriction condition among the event candidates, and
the engine layer is further configured to store the selected event in an event queue in order of high priority, sequentially proceed with the selected event stored in the event queue, and
the engine layer is further configured to delete the selected event whose progress has ended from the event queue, and
based on all selected events stored in the event queue being deleted, the engine layer is further configured to terminate the discrete event simulation and output simulation result data.

12. The semiconductor processing system of claim 11, wherein the processor further comprises a visualization layer visualizing the simulation result data.

13. The semiconductor processing system of claim 11, wherein the processor further comprises a data layer storing the system data, the event candidate, the selected event, and the simulation result data.

14. The semiconductor processing system of claim 11, wherein the system data comprises at least one of a configuration of the plurality of processing modules, a relationship between the plurality of processing modules, a layout of the plurality of processing modules, a process recipe, time of a given event, and a process parameter.

15. The semiconductor processing system of claim 14, wherein the time of the given event comprises an operation time of the plurality of processing modules according to the given event and a movement time for the wafer to move between the plurality of processing modules.

16. The semiconductor processing system of claim 14, wherein the process parameter comprises at least one of RF power, fluid pressure, a fluid flow rate, chamber pressure, and temperature.

17. The semiconductor processing system of claim 11, wherein the engine layer is further configured to select, as the event candidate, at least one second event that may occur after a first event in progress on the wafer is completed, in consideration of a first state of the plurality of processing modules and a first state of the wafer.

18. The semiconductor processing system of claim 11, wherein the engine layer is further configured to determine priority based on an end time of the selected event.

19. The semiconductor processing system of claim 11, wherein the restriction condition comprises at least one of a failure of a processing module in which the event candidate occurs and introduction of another wafer into the processing module in which the event candidate occurs.

20. A semiconductor processing system comprising:
a plurality of processing modules in which an event occurs for a lot defined as a group of a plurality of wafers; and
a processor configured to receive system data related to the event and the plurality of processing modules and perform discrete event simulation of an order of occurrence of the event,
wherein the processor is further configured to select at least one event that may occur after an end of an earlier-ending event performed on one of the plurality of wafers as an event candidate of a plurality of event candidates using the system data and the processor is further configured to determine, as a selected event, one event exceeding a restriction condition among the plurality of event candidates,
the processor is further configured to store the selected event in an event queue in order of high priority, sequentially proceed with the selected event stored in the event queue, and delete the selected event whose progress has ended from the event queue, and
based on all selected events stored in the event queue being deleted, the processor is further configured to terminate the discrete event simulation and output simulation result data including a start time and an end time of the selected event.
